(19) United States
(12) Patent Application Publication
(10) Pub. No.: US 2021/0035239 A1
(43) Pub. Date: Feb. 4, 2021

(54) SYSTEM AND METHOD FOR DELIVERING REAL TIME CONTEXTUAL AND LOCATION BASED TARGETED COMMUNICATION ON MOBILE AND INTERNET BASED CHANNELS VIA RICH COMMUNICATION SERVICES

(71) Applicant: Mavenir Networks, Inc., Richardson, TX (US)

(72) Inventors: Manish SRIVASTAVA, McKinney, TX (US); Bejoy PANKAJAKSHAN, Allen, TX (US)

(73) Assignee: Mavenir Networks, Inc., Richardson, TX (US)

(21) Appl. No.: 17/064,281

(22) Filed: Oct. 6, 2020

Related U.S. Application Data
(63) Continuation of application No. PCT/US2019/026285, filed on Apr. 8, 2019.
(60) Provisional application No. 62/662,533, filed on Apr. 25, 2018.

(51) Int. Cl. G06Q 50/00; H04L 12/58; G06F 40/30; G06Q 30/02

(52) U.S. Cl. CPC G06Q 50/01; H04L 51/18; H04L 51/04; G06F 40/30; G06N 3/08; G06Q 30/0255; G06Q 30/0267; G06Q 30/0261; G06Q 30/0277

(57) ABSTRACT

A system and a method utilize RCS-based mobile communication mechanism to deliver targeted real-time communications based on the context of a particular conversation, which context of conversation is considered to refine the targeted real-time communication. The component messages of a P2P or a group RCS message conversation are threaded by a server based on the unique conversation ID, and an analytics server uses machine learning algorithms to identify the context of the conversation. The system and method can utilize a server implementing Natural Language Processing (NLP) and machine-learning capabilities to identify the intent of the conversation and suggest chatbot options and/or suggestions to client(s) at least partly based on the identified intent of the conversation. The chatbot suggestions can be provided in the conversation window on the mobile device based on the conversation context.

### CROSS REFERENCE TO RELATED APPLICATIONS

The present application is a continuation application of International (PCT) application No. PCT/US2019/026285 filed on Apr. 8, 2019 which claims priority to U.S. Provisional Patent Application No. 62/662,533, filed on Apr. 25, 2018, both of which are incorporated herein by reference in their entireties.

### BACKGROUND OF THE DISCLOSURE

### Field of the Disclosure

The present disclosure relates to a system and a method for delivering real-time context-based and/or location-based targeted communications and/or chatbots on mobile- and Internet-based channels via Rich Communication Services (RCS).

### Description of the Related Art

Several platforms for providing targeted communications to participant(s) of conversations on mobile- and Internet-based channels exist, but the implementations of the targeted communications are rather simplistic and limited. On one existing platform, targeted communications, e.g., schedule change, advertising and notices, are provided based on the social graph of a user profile and the interest shown by the user in connection with multiple social events. On another platform, targeted communications can be based on the user's browsing history and interest shown by the user across various websites and search results. On another platform, targeted communications (e.g., schedule change, advertising and notices) can be provided on the apps (clients) running on a phone, but these ads are offline ads and not based on user conversation context and/or specific user location.

### BRIEF SUMMARY OF THE DISCLOSURE

In the context of providing a service involving Messaging as a Platform (MaaP), Rich Communication Services (RCS) is a messaging product based on GSMA (Global System for Mobile Communications) specification of RCS-5.3 messaging standard which is being deployed by multiple telecom operators worldwide. Given the increasing interest in implementing universal profile in messaging, RCS is now being deployed by multiple telecom operators as the evolution of messaging clients from current Short Message Service (SMS) and/or Multimedia Messaging Service (MMS) capabilities. RCS enables real-time delivery notifications, file transfers (e.g., up to 100 MB), and one-to-one and group-chat features.

Messages transmitted via an RCS channel can be used to identify the actual conversation context, which context can be utilized as a powerful tool to serve real-time location and context-specific communications, e.g., notifications, schedule changes and advertisements.

In one example embodiment, an RCS server which is deployed in the operator's network is provided in the path of all RCS messages which are transmitted in the network. RCS server can be built on top of GSMA RCS standard. The RCS server can be provided with a message processing layer which taps all the user messages and sends the user messages to the MaaP platform, e.g., a platform implemented using one or more server(s).

On the MaaP platform, user messages in a particular conversation thread or stream (e.g., part of a peer-to-peer (one-to-one) messaging or group messaging) are merged together based on conversation ID, which ID is unique for each conversation thread as per the RCS-5.3 specifications. The merged messages of a conversation thread are fed as input to an analytics server, e.g., running as a part of the MaaP platform node.

The analytics server uses, e.g., machine learning algorithms, to identify the context of the conversation, which can be P2A (person-to-application), A2P (application-to-person), P2P (peer-to-peer), and/or group chat, for example. These examples are not to be construed as limiting. The identified context of the conversation and the actual conversation are then fed into an algorithm (e.g., implemented on the analytics server) which uses the Natural Language Processing (NLP) to identify the intent of the conversation within the identified context. Based on the identified context and the identified conversation intent, the analytics server can predict the need to show, e.g., to an end user of a mobile device having a client thereon, one or more of the following example items in the message conversation window: (i) real-time contextual notices (e.g., schedules, notices, advertisements); (ii) rewards points associated with each ad view; and (iii) available options involving chatbots.

In an example embodiment, the analytics server can show to the end user(s) the options of available chatbots with which the end user(s) can chat in the identified context without adding bots in the contacts of the end user, and no need exists for the end user(s) to discover chatbots separately. This capability provides a significant advantage over the conventional chatbot messaging technique, which is implemented using a defined procedure in which a client, e.g., application programming interface (API), has to discover the available bots in the network, add the available bots to the contacts, and then send messages to the bots. Examples of currently available chatbots include those available via Facebook™ and Skype™ messengers, which messengers require one to search for the bots and then send messages to the bots. In contrast, using the system and the technique disclosed herein, the need to search for a bot is eliminated by automatically providing a chatbot, e.g., in the RCS messaging window, based on the identified conversation context.

The present disclosure provides a system and a method using RCS-based mobile communication mechanism to deliver targeted real-time communications based on the context of a particular conversation thread or stream.

The present disclosure provides a system and a method using RCS-based mobile communication mechanism to deliver targeted real-time communications based on the context of a particular conversation stream or thread, which context of conversation is considered in connection with the location of the RCS client to refine the targeted real-time communication, e.g., specific notice or advertisement.

The present disclosure provides a system and a method using RCS-based mobile communication mechanism to deliver targeted real-time communications based on the context of a particular conversation stream or thread, in which system and method component messages of a P2P or a group RCS message conversation are threaded (or tied together) by a server (e.g., on a MaaP platform) based on the conversation ID, which ID is unique for each conversation thread.

The present disclosure provides a system and a method using RCS-based mobile communication mechanism to deliver targeted real-time communications based on the context of a particular conversation stream or thread, which system and method utilize an analytics server that uses, e.g., machine learning algorithms, to identify the context of a specific conversation stream or thread formed by a component set of messages.

The present disclosure provides a system and a method using RCS-based mobile communication mechanism to deliver targeted real-time communications based on the context of a particular conversation stream or thread, which system and method enhance the RCS delivery mechanism to deliver targeted real-time communications, e.g., advertisements and/or notices, to RCS clients. An example enhancement of the RCS delivery mechanism can include, e.g., adding of traffic type header in Common Presence and Instant Messaging (CPIM) namespace in the Message Session Relay Protocol (MSRP) body, and encoding a JavaScript link as a text message in the MSRP body, such that the logic of ads display is encoded in the JavaScript code.

The present disclosure provides a system and a method using RCS-based mobile communication mechanism to deliver targeted real-time communications based on the context of a particular conversation stream or thread, which system and method utilize a server implementing Natural Language Processing (NLP) and machine-learning capabilities to identify the intent of the conversation and suggest chatbot options and/or suggestions to client(s) at least partly based on the identified intent of the conversation. In one example embodiment, chatbot suggestions can be provided in the conversation window on a mobile device based on the conversation context.

The present disclosure provides a system and a method using RCS-based mobile communication mechanism to deliver targeted real-time communications based on the context of a particular conversation stream or thread, which system and method enhance the RCS Message Session Relay Protocol (MSRP) delivery mechanism to deliver chatbot suggestion to an RCS client. An example enhancement of the RCS MSRP delivery mechanism can include, e.g., adding of traffic type header in Common Presence and Instant Messaging (CPIM) namespace in the Message Session Relay Protocol (MSRP) body, and encoding a JavaScript link as a text message in the MSRP body, such that the logic of chatbot display is encoded in the JavaScript code.

In one example embodiment, the chatbots are downloaded into the client based on the information present in the RCS messages and presented to the user as a suggestion to chat. In another example embodiment, the downloaded chatbots are added into the user's contacts and then presented as a suggestion to chat. In one example embodiment, the chatbots suggestion is displayed for a limited time in the conversation window on top as a banner, after which limited time the banner is discarded.

### BRIEF DESCRIPTION OF THE DRAWINGS

FIG. 1a shows an overall system architecture of an example embodiment of the system according to the present disclosure.

FIG. 1b shows a block diagram illustrating the relationship among the chatbot store, the ads store, and the context-based message analysis.

FIG. 2 illustrates the component steps/blocks of an example method according to the present disclosure.

FIG. 3 illustrates the message flow in an operator network according to the present disclosure.

FIG. 4 illustrates component logic blocks of an example context analysis and intent analysis.

FIG. 5 illustrates an example list of context categories as displayed on a mobile device display.

FIGS. 6a-6b illustrate examples of targeted communication provided in the message conversation window as banner.

FIG. 7 illustrates the system architecture corresponding to the system architecture shown in FIG. 1, with functionalities for chatbot depicted.

### DETAILED DESCRIPTION OF DISCLOSURE

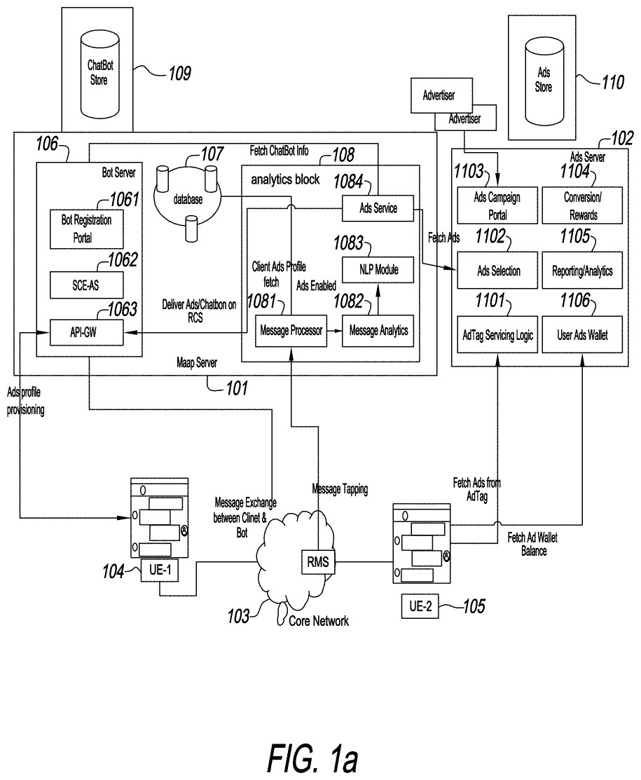

FIG. 1a shows an overall system architecture of an example embodiment of the system according to the present disclosure. The example embodiment of the system shown in FIG. 1 includes an MaaP server node 101 (also referred to as a messaging server node) and a targeted communication server, e.g., an ads server 102, which servers are operatively coupled to each other, as well as to the core network 103 and a first user equipment (UE-1) 104 and a second user equipment (UE-2) 105. Although the ads server is shown in this example embodiment as a targeted communication server, other types of servers (e.g., schedulers, etc.) can be utilized as a targeted communication server. The core network implements, among other functions, right management services (RMS).

As shown in FIG. 1a, the MaaP server node 101 can include a bot server 106, a database 107, and an analytics block 108. A chatbot store 109 is associated with the bot server 106. The bot server 106 can include, among other components, bot registration portal 1061, service creation environment application server (SCE-AS) 1062, and application programming interface gateway (API-GW) 1063. The analytics block 108 of the MaaP server node can include a message processor 1081, message analytics module 1082, NLP module 1083 and an ads service module 1084. An ads store 110 is associated with the ads server 102. The ads server 102 can include, among other component blocks, a targeted communications serving logic module (e.g., an AdTag serving logic module 1101), ads selection module 1102, ads campaign portal 1103, conversion/rewards module 1104, reporting/analytics module 1105, and user ads wallet module 1106.

FIG. 1b shows a simplified block diagram illustrating the relationship among the chatbot store 109, the ads store 110, and the context-based message analytics (e.g., analytics block 108 shown in FIG. 1a) to provided targeted communications, e.g., ads, apps and chatbots.

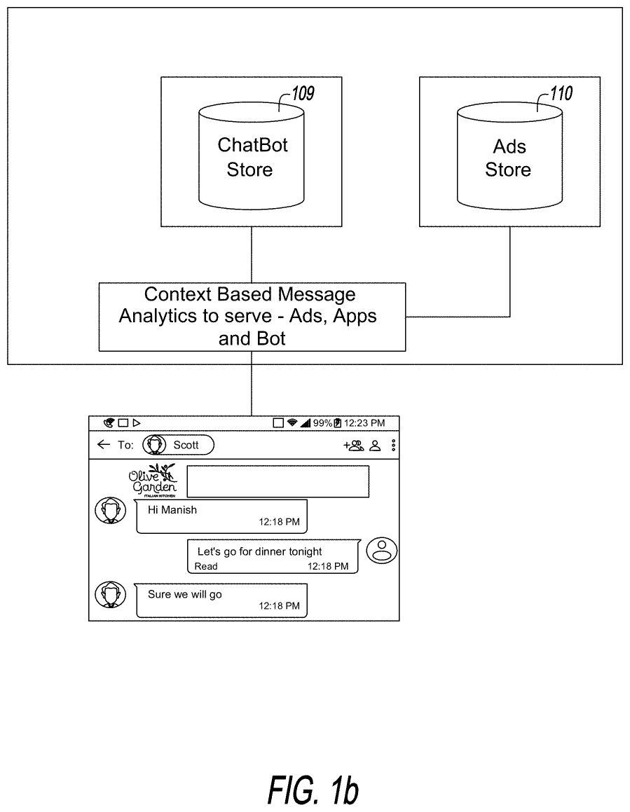

FIG. 2 is a high-level flow diagram illustrating the component steps/blocks of an example method 200 according to the present disclosure. The component steps/blocks shown in the flow diagram of FIG. 2 include the following. At block 201, a particular or unique conversation stream (e.g., a series of messages) between a pair of users is identified. At block 202, machine learning analytics is run over the particular conversation stream to identify the category (or categories) of conversation and associated keywords. At block 203, NLP is run over the particular conversation stream, optionally with additional input of context, to identify whether a chatbot needs to be suggested to at least one of the users involved in the conversation stream. At block 204, the identified categories of conversation and the associated keywords are outputted and sent, e.g., to the ads server 102. At block 205, a chatbot platform (e.g., bot server 106 of the MaaP server node 101) provides a chatbot suggestion.

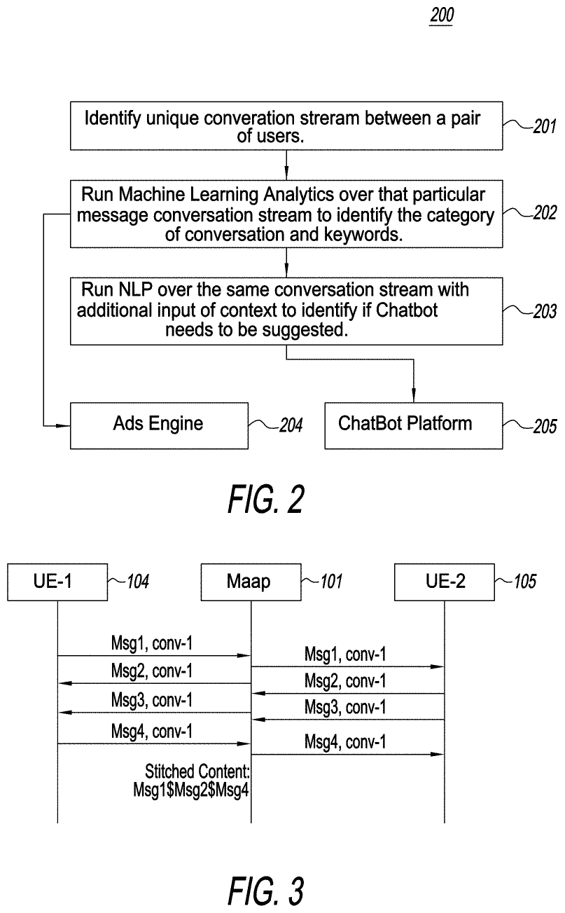

As shown in FIG. 3, which illustrates the message flow in an operator network, every message in an operator network passes through the messaging server node (represented by MaaP server node 101 in FIGS. 1a and 3). The messaging server needs to identify and segregate the messages belonging to each conversation thread between a pair of users, e.g., UE-1 104 and UE-2 105 shown in FIG. 1a. The messages between each pair of users are stitched together as a conversation thread or stream (designated as “stitched content” in FIG. 3). The messaging server node (e.g., MaaP server node 101) maintains a hash table (an example of which is shown below) with the pair of numbers as key. Source and destination numbers are identified for each message and entered in the hash table accordingly. There is a system-wide configuration to keep the messages in the system queue. Once the messages count in the particular conversation thread or stream reaches a predefined threshold count, the analytics engine (e.g., the message analytics module 1082) implements the analysis on the set of messages in the particular conversation thread or stream.

Hash Table on the server →

| | | | |
|---|---|---|---|
| Msg1 | Msg2 | Msg3 | Msg4 |

Key = Conv-1
Message stream − Msg1$Msg2$Msg3$Msg4
P2P = UserA_UserB
Message Count = 4 → used to match the minimum threshold count before the analytics process start.

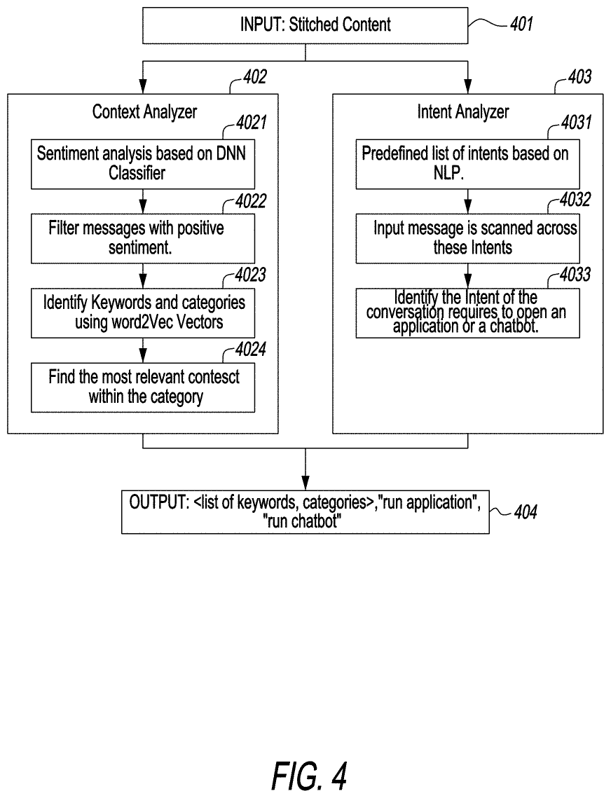

FIG. 4 illustrates component logic blocks of an example context analysis (e.g., by context analyzer 402, which can be implemented at the MaaP server node 101) and intent analysis (e.g., by intent analyzer 403, which can be implemented at the MaaP server node 101) based on the stitched content including messages of a particular conversation stream or thread, which component logic blocks can be implemented in software (e.g., stored in computer-readable medium) and/or in hardware. Although FIG. 4 depicts context analysis and intent analysis in parallel, this is not to be construed as limiting, i.e., context analysis and intent analysis can be performed at different times.

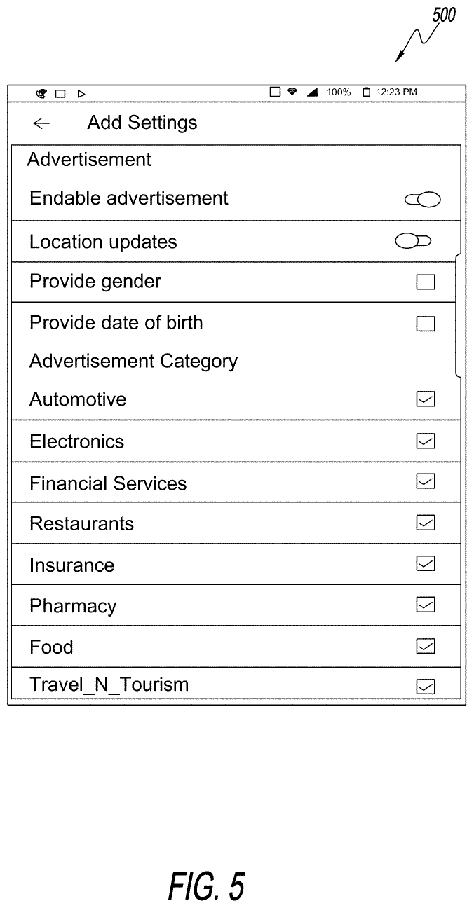

In an example embodiment shown in FIG. 4, a machine-learning algorithm, e.g., Word2Vec model from TensorFlow™, can be deployed (e.g., as a part of the context analyzer 402) to identify the context of a conversation thread or stream. At block 401, the stitched content including the messages of a particular conversation is inputted, e.g., into the analytics block 108. At block 4021, sentiment analysis is performed utilizing a neural network classified algorithm, e.g., DNN (deep neural networks) Classifier from TensorFlow™. As shown at block 4022, the messages with positive sentiment can be initially filtered using the DNN Classifier. Once the messages with positive sentiment have been identified, the Word2Vec model can be applied (e.g., at block 4023) to the messages with positive sentiment to identify one or more categories and a list of keywords in the conversation associated with the one or more categories. In this manner, as shown at block 4024, the most relevant context of the conversation can be identified with one or more categories and a list of keywords in the conversation associated with the one or more categories. Example context categories can include food, travel, environment, automotive, restaurants, pharmacy, etc., as illustrated in FIG. 5, which depicts an example list of context categories as displayed on a mobile device display 500. The output context can be a combination of the identified category and the associated set of keywords, e.g., Italian food with pizza, Italian food with mushrooms, car with electric, car with red color, Ford™, etc.

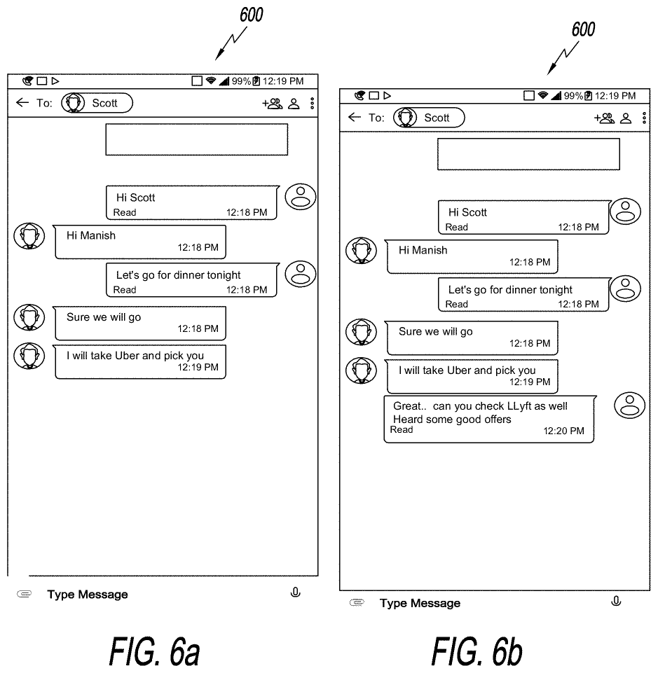

The identified categories and the associated keywords in the conversation thread or stream are outputted and sent, e.g., to the ads server 102, which has a pool of advertisements for each category. The ads server scans for the keywords in the pool of advertisements for the relevant category. The advertisement with the highest matching score can be delivered to the user. Examples of context-based advertisements delivered to the user(s) are shown in FIGS. 6a and 6b, which depict banner ads provided within the conversation windows of display 600 of user equipment(s), which can be mobile phones or computer devices, for example. Although advertisements are described as an example of targeted communication, other types of targeted communication can be delivered, e.g., scheduling change, etc.

In an example embodiment according to the present disclosure, the MaaP server node can also identify, based on the stitched content including the messages of a particular conversation stream or thread, the intent of the user(s) as evidenced by the conversation, and whether the users require any help, e.g., with chatbots and/or applications. For example, if the MaaP server node 101 determines that the users are talking about a movie and showing an intent to buy movie tickets, the MaaP server node 101 can provide a chatbot suggestion, e.g., in the message conversation window of a user equipment, for one or more pertinent movie theater(s) at which the users can purchase tickets and/or watch the movie.

As shown in FIG. 4, in the intent analysis (e.g., by the intent analyzer 403), the messages of a particular conversation stream or thread are processed by a natural language processing (NLP) application (e.g., implemented at the NLP Module 1083 in the analytics block 108 of the MaaP server node 101 shown in FIG. 1a) to identify the intent of the conversation. At block 4031, a list of intents (e.g., from a predefined list of intents) is identified based on the NLP application. At block 4032, inputted stitched content is examined to identify the intent of the conversation stream or thread. In addition, and/or optionally, the intent analyzer 403 (e.g., as implement at the MaaP server node 101) can further refine the intent based on the context of the conversation stream or thread. The determined intent and/or the context can serve as a basis for providing a chatbot and/or an application suggestion. For this, as shown at block 4033, it is determined whether the determined intent requires opening an application or a chatbot suggestion, and if so, at block 404, an application or a chatbot suggestion can be provided. As an example, if the determined intent and/or the context of the conversation is Italian food, a chatbot suggestion can be provided for one or more Italian restaurant(s) in the relevant area of one or more of the user(s).

In an example embodiment according to the present disclosure, AdTag technology is deployed to display ads on the user equipment(s), e.g., mobile phones or computer devices. Whenever the ads server 102 finds one or more ads matching the input criteria, e.g., the determined context and associated keywords, the ads server creates a unique JavaScript link for the one or more matching ads. This unique JavaScript link, which is called an AdTag, is encoded in an xml body. The AdTag is then encoded in the multi-part body of the message sent to a client (e.g., on a user equipment), which message can be an RCS Message Session Relay Protocol (MSRP) message. The body of the message sent to the client further includes a header, “Traffic-Type: advertisement.”

The client receives the MSRP message (an example of which is shown below) and identifies that this message is an advertisement based on the “Traffic-Type: advertisement” header. After the client identifies the advertisement message, the client opens a web-view on top of the corresponding conversation thread in the conversation window of the user equipment's display. The client then executes the JavaScript link in the web-view. The JavaScript can be hosted on the ads server 102. Once the JavaScript is executed, the ads server takes control of the web-view and starts displaying the one or more ad(s) in that web-view. In the case of multiple ads, the ad server can also rotate and show the multiple ads in carousel format.

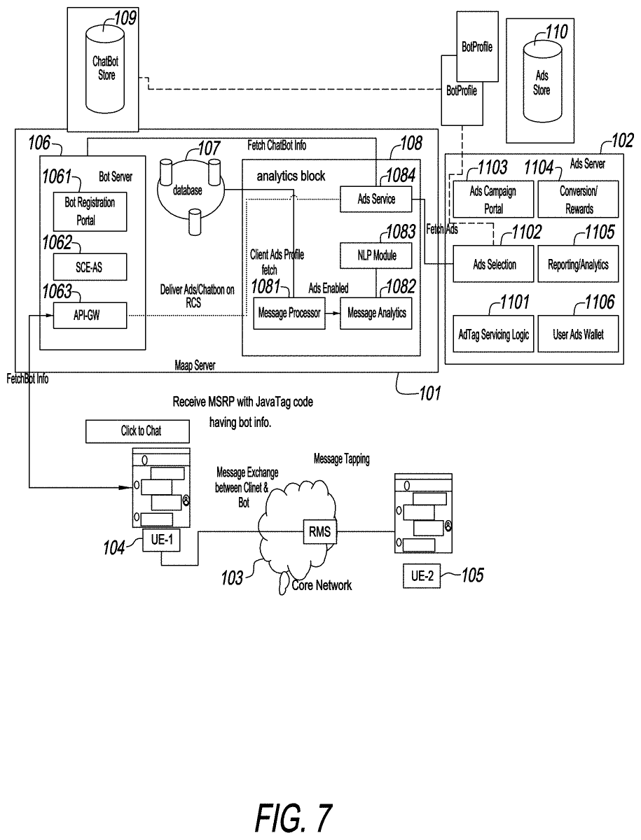

FIG. 7 illustrates the system architecture corresponding to the system architecture shown in FIG. 1, which FIG. 7 depicts functionalities associated with chatbot display. When a chatbot is initially onboarded (or registered) on the MaaP server node 101, the MaaP server node 101 generates a unique bot ID for the chatbot. For each chatbot, the MaaP server node 101 stores a chatbot profile, the corresponding categories, and the unique bot ID. For each registered chatbot on the MaaP server node 101, a corresponding profile is created on the ads server 102, which corresponding profile on the ads server 102 includes associated keywords and categories for each registered chatbot.

Once the MaaP server node 101 performs context analysis (and/or intent analysis) on a conversation and identifies the relevant category and keywords for the conversation, the ads server 102 searches for an available chatbot with a matching profile of relevant category and/or keywords. If a matching chatbot is found, then the ads server 102 transmits the matching chatbot ID information to the MaaP server node 101. The MaaP server node 101 encodes the url for the chatbot with a specific link and a prefix in a JavaScript code, and the link to this JavaScript code is sent to a client (e.g., an app on at least one of the user equipments UE-1 104 and UE-2 105) along with a Common Presence and Instant Messaging (CPIM) namespace (or header or prefix) in the RCS Message Session Relay Protocol (MSRP) message body, which header indicates a chatbot message, and the logic of chatbot display is encoded in the JavaScript code. RCS messaging treats this as a text or a link being sent.

Once a client receives the chatbot message, the client parses the message and understands that it's a JavaScript code. The client then creates a web-view banner on top and executes the JavaScript code, which has a link to the specified chatbot ID and url. The client then downloads the specified chatbot profile information from the MaaP server node 101 based on the chatbot ID and presents a box to a user about a chatbot suggestion. When the user chooses the chatbot, the client will open up a messaging window for the user to do chatbot messaging.

As described above, the system and method described in the present disclosure provide several advantages. By analyzing the RCS peer-to-peer (P2P), person-to-application (P2A), application-to-person (A2P), and/or Group chat conversation(s) to determine the overall context and/or intent evidenced by the overall conversation stream or thread, the system and method of the present disclosure are able to take into consideration the overall context that is relevant to all parties involved in the conversation, and provide targeted communications, e.g., ads, notices, apps and/or chatbot suggestions, based on the overall context of the conversation stream or thread, rather than based on the context of only an individual message. In addition, chatbot(s) can be brought into conversation(s) directly from the platform based on the determined conversation context, which eliminates the need for a user to initially discover the bots and/or the need to know whether any pertinent chatbot exists. By utilizing the system and method according to the present disclosure, system operators can greatly expand the reach of chatbots.

In this document, the term “computer-readable medium” generally refers to media such as removable storage drive, a hard disk installed in hard disk drive, and the like, which media serve as storage for computer programs that can be provided to, and executed by, computer systems. Computer programs can also be received via a communications interface. Computer programs, when executed, enable the computer system to perform the features of the present invention, as discussed herein. In particular, the computer programs, when executed, enable a processor to perform the features of the example embodiments of the present disclosure.

The example embodiments according to the present disclosure can be implemented primarily in hardware using, for example, hardware components such as application specific integrated circuits (ASICs). Implementation of the hardware state machine so as to perform the functions described herein will be apparent to persons skilled in the relevant art(s). Alternatively, the example embodiments according to the present disclosure can be implemented using a combination of both hardware and software.

While various example embodiments of the present disclosure have been described above, the example embodiments are merely exemplary and should not be interpreted as limiting. It will be apparent to persons skilled in the relevant art(s) that various changes in form and detail can be made therein, and these variations are fully encompassed by the present disclosure.

1. A method of providing Rich Communication Services (RCS) protocol communication, comprising:
analyzing, by a messaging as a platform (MaaP) server, messages in an RCS protocol conversation between at least a first user equipment and a second user equipment to determine a context of the conversation, wherein the messages in the conversation are displayed in a conversation window of at least one of the first user equipment and the second user equipment;
generating, by a targeted communication server, real-time targeted communication based at least on the determined context of the conversation;
transmitting, by the targeted communication server, an RCS message containing a JavaScript link to at least one of an RCS client associated with the first user equipment and an RCS client associated with the second user equipment; and
executing the JavaScript to display the targeted communication in the conversation window displayed on at least one of the first user equipment and the second user equipment.

2. The method of claim 1, wherein the determined context of the conversation is linked with a location of at least one of the RCS client associated with the first user equipment and the RCS client associated with the second user equipment, and wherein the real-time targeted communication is generated based at least on the determined context of the conversation and the location of at least one of the RCS client associated with the first user equipment and the RCS client associated with the second user equipment.

3. The method of claim 1, wherein:
the conversation is one of a peer-to-peer RCS conversation or a group RCS conversation; and
component messages of the conversation are identified by a unique conversation ID for the conversation and grouped by the MaaP server using the unique conversation ID.

4. The method of claim 1, wherein a message analytics component of the MaaP server executes message analytics on messages from both the first user equipment and the second user equipment to identify the context of the conversation.

5. The method of claim 1, wherein the real-time targeted communication includes an advertisement, and wherein the RCS protocol communication mechanism is enhanced to deliver the advertisement to at least one of the RCS client associated with the first user equipment and the RCS client associated with the second user equipment.

6. The method of claim 1, wherein the MaaP server uses at least one of natural language processing (NLP) and machine-learning capabilities to identify an intent of the conversation and suggest at least one chatbot option to at least one of the RCS client associated with the first user equipment and the RCS client associated with the second user equipment.

7. The method of claim 1, wherein at least one chatbot option is provided in a conversation window on at least one of the first user equipment and the second user equipment based on the determined context of the conversation.

8. The method of claim 1, wherein an enhanced RCS message session relay protocol (MSRP) mechanism is utilized to provide at least one chatbot option to at least one of the RCS client associated with the first user equipment and the RCS client associated with the second user equipment based on the determined context of the conversation.

9. The method of claim 1, wherein at least one chatbot is downloaded into at least one of the RCS client associated with the first user equipment and the RCS client associated with the second user equipment based on at least one of the determined context of the conversation and intent of the conversation, and wherein the at least one chatbot is presented to a user of at least one of the first user equipment and the second user equipment to at least one of (i) chat and (ii) add into contacts of at least one of the first user equipment and the second user equipment and then chat.

10. The method of claim 7, wherein the at least one chatbot option is displayed for a predefined time in a top portion of the conversation window.

11. The method of claim 7, further comprising:
maintaining by the ads server, for each available chatbot, a corresponding profile including at least one associated keyword and at least one category for the respective chatbot;
searching, by the ads server, for a chatbot having a profile corresponding to the determined context of the conversation; and
presenting the chatbot having a profile corresponding to the determined context of the conversation as the at least one chatbot option.

12. The method of claim 7, further comprising:
encoding, by the MaaP server, a uniform resource locator for the at least one chatbot option with a link and a prefix in a JavaScript code, wherein the prefix indicates a chatbot message; and
sending, by the MaaP server, an RCS message including the link and the prefix to at least one of the RCS client associated with the first user equipment and the RCS client associated with the second user equipment.

13. A system comprising:
a targeted communication server, wherein the targeted communication server is operatively coupled to a messaging as a platform (MaaP) server configured to analyze messages in an RCS protocol conversation between at least a first user equipment and a second user equipment to determine a context of the conversation, wherein the messages in the conversation are displayed in a conversation window of at least one of the first user equipment and the second user equipment, and wherein the targeted communication server is configured to:
generate real-time targeted communication based at least on the determined context of the conversation;
transmit an RCS message containing a JavaScript link to at least one of an RCS client associated with the first user equipment and an RCS client associated with the second user equipment; and
execute the JavaScript to display the targeted communication in the conversation window displayed on at least one of the first user equipment and the second user equipment.

14. The system of claim 13, wherein the determined context of the conversation is linked with a location of at least one of the RCS client associated with the first user equipment and the RCS client associated with the second user equipment, and wherein the real-time targeted communication is generated based at least on the determined context of the conversation and the location of at least one of the RCS client associated with the first user equipment and the RCS client associated with the second user equipment.

15. The system of claim 13, wherein:
the conversation is one of a peer-to-peer RCS conversation or a group RCS conversation; and
component messages of the conversation are identified by a unique conversation ID for the conversation and grouped by the MaaP server using the unique conversation ID.

16. The system of claim 13, wherein a message analytics component of the MaaP server executes message analytics on messages from both the first user equipment and the second user equipment to identify the context of the conversation.

17. The system of claim 13, wherein the real-time targeted communication includes an advertisement, and wherein the RCS protocol communication mechanism is enhanced to deliver the advertisement to at least one of the RCS client associated with the first user equipment and the RCS client associated with the second user equipment.

18. The system of claim 13, wherein the MaaP server uses at least one of natural language processing (NLP) and machine-learning capabilities to identify an intent of the conversation and suggest at least one chatbot option to at least one of the RCS client associated with the first user equipment and the RCS client associated with the second user equipment.

19. The system of claim 13, wherein at least one chatbot option is provided in a conversation window on at least one of the first user equipment and the second user equipment based on the determined context of the conversation.

20. The system of claim 13, wherein an enhanced RCS message session relay protocol (MSRP) mechanism is utilized to provide at least one chatbot option to at least one of the RCS client associated with the first user equipment and the RCS client associated with the second user equipment based on the determined context of the conversation.
